(19) United States
(12) Patent Application Publication
(10) Pub. No.: US 2005/0238778 A1
(43) Pub. Date: Oct. 27, 2005

(54) Composition of matter comprising xylitol, natural and/or artificial flavors, and a flavor enhancer

(76) Inventor: Charles Michael Coppedge, Cape Coral, FL (US)

Correspondence Address: Charles Michael Coppedge;Suite #1, 601 N. Del Prado, Cape Coral, FL, 33909, US

(21) Appl. No.: 10/832,720

(22) Filed: Apr. 27, 2004

(51) Int. Cl. A23L 1/22

(52) U.S. Cl. 426/548

(57) ABSTRACT

A composition of matter with xylitol, natural and/or artificial flavors, and a flavor enhancer: Xylitol is a 5-carbon polyol which is antimicrobial and more alkaline enhancing that 6-carbon sugars making it an excellent sucrose substitue that protects teeth. Xylitol also has a very low glycemic index making it a better choice over sucrose to help the consumer ovoid insulin resistance. Flavor(s) and flavor enhancer(s) are added for variation and appeal by extending and enhancing sweetness and flavor.

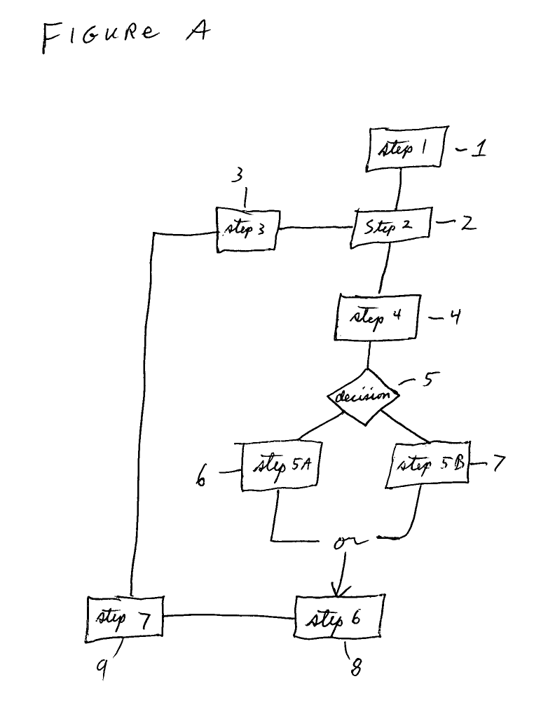

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of sweetening agents and more specifically to a composition of matter comprising xylitol, natural and/or artificial flavors, and a flavor enhancer.

Xylitol was discovered in Germany in 1891. World War II brought shortages of sucrose that necessitated alternative sweetener usage. Finland pioneered use of xylitol during that time and it is currently popular in Germany, Switzerland, Finland, the Soviet Union and Japan as a preferred sweetener in diabetic diets and in patients with insulin resistance. Usage in the United States is low because of the cheap supplies of cane and beet sugar making xylitol less economically viable.

Xylitol is currently available as a sucrose substitute. However, it is more expensive and less known than sucrose making it far less popular.

Powdered flavorings are available but they are usually bulked with dextrose, maltose, maltodextran and/or sucrose.

Sucrose is well known to be consumed in huge quantities by humans and is a leading cause of diabetes, insulin resistance, obesity, cardiovascular disease, tooth decay, impaired learning in children and many other serious health issues.

Xylitol is known to be superior to sucrose in terms of health but due to price and slightly less sweetness than sucrose, has not been particularly popular.

Powdered flavorings are available but they are usually bulked with dextrose, maltose, maltodextran and/or sucrose making them less than ideal. They are also not sweetened for table top usage.

### BRIEF SUMMARY OF THE INVENTION

The primary advantage of the invention is to provide a new composition of matter that is a desirable alternative to sugar (sucrose) with better taste character.

Another advantage of the invention is to provide a new composition of matter that offers a suitable substitute for sugar (sucrose) with lower calories and lower glycemic index.

Another advantage of the invention is to provide a new composition of matter as an option to sugar (sucrose) that may protect teeth from dental caries.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a composition of matter comprising xylitol, natural and/or artificial flavors, and a flavor enhancer: Xylitol is used as a basis for this new composition of matter, with flavor added for variation, and flavor enhancer to extend and enhance sweetness and flavor.

### BRIEF DESCRIPTION OF THE DRAWINGS

The drawings constitute a part of this specification and include exemplary embodiments to the invention, which may be embodied in various forms.

FIGURE A is a flow chart of the operations that comprise the method of manufacture.

In accordance with the present invention, FIGURE A shows the sequence of steps involved in the manufacture of invention. All percentages are by weight/weight.
1) Weight out appropriate amount of xylitol
2) Split out 5% for flavoring process
3) Pour other 95% of xylitol into V-Mixer
4) Add 0.07% neotame to the 5% xylitol fraction-mix well to coat xylitol crystals
5) Determine if liquid flavor concentrate or dry powder flavor concentrate to be used based on choice and availability
6) If dry powder flavor used, add 4% and combine with 5% xylitol fraction with neotame with adequate mixing
7) If liquid flavor concentrate used, add 1.5% and combine with 5% xylitol fraction with neotame with adequate mixing. Mix quickly so as not to dissolve crystals.
8) Pour flavored xylitol fraction into V-Mixer with balance of xylitol from step 3
9) Blend in V-Mixer for 15 minutes.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

In accordance with the present invention, FIGURE A shows the sequence of steps involved in the manufacture of said invention. These steps show a composition of matter comprising xylitol as the base and the addition of natural and/or artificial flavoring and a flavor enhancer (neotame) so that an incredibly delicious sugar replacement can be produced. In the preferred embodiment, the finished product will be in crystal form to aid in pourability. However, provision is made for the alternate embodiment to be in powder form to aid in more rapid dissolution if required for certain food productions. An additional provision is made for the option of using a different flavor enhancer such as sucralose or aspertame. Finally, provisions are made for use of either liquid or powder flavor concentrates for more variations.

In the present form of the invention, a new and previously unavailable product will be offered to the general public that can be used in place of table sugar (sucrose) that has more appeal due to the variety of flavor choices. The invention also has more sweetness than sugar due to the inclusion of the neotame to extend and enhance flavoring, further broadening its appeal. It is the inventors opinion that people will enjoy the sweet flavors more than sucrose and thereby benefit themselves with a healthier alternative. In the long run the entire health care system could benefit from reduction of obesity and dental caries as well as better control of diabetes. Current studies underway are analyzing the potential for xylitol to help decrease osteoporosis. Other research suggests that school aged children would think sharper and be more alert if they used xylitol in place of sugar due to the enormous difference in glucose load on insulin. The decreased affect on insulin should also decrease insulin resistance. The inventors goal is to make the xylitol taste better to increase the desirability for its substitution for sugar.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A composition of matter comprising xylitol, natural and/or artificial flavors, and a flavor enhancer:
xylitol used a basis for this new composition of matter;
with flavor added for variation;
and flavor enhancer to extend and enhance sweetness and flavor.
